(19) United States
(12) Patent Application Publication
(10) Pub. No.: US 2016/0102242 A1
(43) Pub. Date: Apr. 14, 2016

(54) TREATMENT FLUID AND METHOD

(71) Applicant: SCHLUMBERGER TECHNOLOGY CORPORATION, Sugar Land, TX (US)

(72) Inventors: Andrey Fedorov, Missouri City, TX (US); Bernhard Lungwitz, Houston, TX (US); Olesya Levanyuk, Tyumen (RU); Philippe Enkababian, Richmond, TX (US)

(21) Appl. No.: 14/969,258

(22) Filed: Dec. 15, 2015

Related U.S. Application Data
(62) Division of application No. 13/475,122, filed on May 18, 2012.

(51) Int. Cl. C09K 8/74

(52) U.S. Cl. CPC C09K 8/74; C09K 2208/30

(57) ABSTRACT

A treatment fluid made of mineral acid, viscoelastic surfactant, at least one of a fluoride source and a chelant, and optionally a corrosion inhibitor. A method of combining a mineral acid, viscoelastic surfactant, at least one of a fluoride source and a chelant, and optionally a corrosion inhibitor, in a fluid mixture. A method of contacting a low-temperature formation with a fluid mixture of mineral acid, viscoelastic surfactant, at least one of a fluoride source and a chelant, and optionally a corrosion inhibitor.

### RELATED APPLICATION DATA

None.

### BACKGROUND

The statements in this section merely provide background information related to the present disclosure and may not constitute prior art.

Treatment of low temperature carbonate formations with a viscoelastic diverting acid (VDA), e.g., at shallow depths and/or in colder climates, is difficult because reactions that occur at higher temperatures may be retarded due to unfavorable reaction kinetics or the reaction(s) may not occur at all. Moreover, at the low temperatures, the viscosity of the VDA may become too high too soon before the acidizing is sufficiently completed. As one example, acidizing a dolomite formation at a temperature at or below 30° C. to enhance permeability to the flow of reservoir fluids is difficult with a VDA because the reaction proceeds very slowly and/or insoluble reaction products such as calcites may be formed. Therefore, there is a need in the art for treatment fluids and methods to treat formations at a low temperature.

### SUMMARY

In some embodiments, a treatment fluid comprises a mineral acid, a surfactant and one or both of a fluoride source and/or a chelant. In some embodiments, a formation is contacted with the treatment fluid. In some embodiments, a rate of dissolution of a formation is increased by adding a fluoride source, a chelant or a combination thereof to a treatment fluid.

### DETAILED DESCRIPTION OF SOME ILLUSTRATIVE EMBODIMENTS

The description and examples are presented solely for the purpose of illustrating the different embodiments of the current application and should not be construed as a limitation to the scope and applicability of the current application. While any compositions of the present application may be described herein as comprising certain materials, it should be understood that the composition could optionally comprise two or more chemically different materials. In addition, the composition can also comprise some components other than the ones already cited.

While embodiments of the current application may be described in terms of treatment of vertical wells, it is equally applicable to wells of any orientation. Moreover, the embodiments of the current application will be described for hydrocarbon production wells, but it is to be understood that the embodiments of the current application may be used for wells for production of other fluids, such as water or carbon dioxide, or, for example, for injection or storage wells.

It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. When a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

In some embodiments, a treatment fluid comprises mineral acid, viscoelastic surfactant (VES), and at least one of a fluoride source and a chelant. In some embodiments, a method comprises combining the mineral acid, viscoelastic surfactant, fluoride source and/or chelant in a fluid mixture. In some embodiments, a method comprises contacting a low-temperature formation with a fluid mixture of mineral acid, viscoelastic surfactant and at least one of a fluoride source and a chelant.

In some embodiments, a treatment fluid comprises mineral acid, viscoelastic surfactant (VES), fluoride source and optionally a corrosion inhibitor. In some embodiments, a method comprises combining the mineral acid, viscoelastic surfactant, fluoride source and optionally the corrosion inhibitor in a fluid mixture. In some embodiments, a method comprises contacting a low-temperature formation with a fluid mixture of mineral acid, viscoelastic surfactant, fluoride source and optionally the corrosion inhibitor.

In some embodiments, a method can include enhancing permeability of a treated formation. For example, the formation can be in communication with an injection well and the method can include injecting fluid into the formation, for example, following shut in with the treatment fluid in contact with the formation. If desired, the fluid injection can occur directly following shut in without flowback from the formation. In some embodiments, the well can be a production well and the method can include producing a fluid from the formation following the formation treatment.

Acid stimulation increases production of oil and gas from carbonate reservoirs. The injected acid dissolves the minerals in the formation and creates conductive flow channels known as wormholes that facilitate production. When reservoirs with different zones of permeability are treated with acid, the acid flows preferentially into the high permeability zones and may not stimulate the low permeability zones. To stimulate the low permeability zones, the acid may be diverted from the high to the low permeability zones. Similarly, when long enough intervals are treated with acid, diversion is used to obtain a non-heterogeneous injection profile.

Some embodiments of a method used to divert acid involves mixing a viscoelastic surfactant (VES) with the acid into the treatment fluid injected into the formation, for example, prior to injection of the acid into the formation either below a fracture pressure for matrix acidizing, or above for fracturing. In embodiments, the VES is a surfactant that under certain conditions can impart viscoelasticity to a fluid.

The viscosity of certain mixtures of acid and VES depends on the concentration of acid in some embodiments. The viscosity of the mixture may be low when the mixture is strongly acidic and the viscosity may increase as the acid spends in the formation. This increase in viscosity causes increased resistance to flow in the high permeability zone during matrix acidizing, leading to a build-up of pressure that promotes diversion of the flow of treating fluid to relatively lower permeability zones. In these embodiments, such a fluid is called a viscoelastic diverting acid, or VDA.

Similarly, in acid fracturing embodiments, the growing fracture may encounter or create high-permeability regions through which acid, which is incorporated in the fluid so that it can etch the fracture faces, leaks off into the formation. Inhibiting this loss of acid is called leakoff control. At best, excessive loss of acid is inefficient and wasteful of acid; at worst, the excessive loss of acid may reduce or eliminate fracture growth. In some embodiments, the same compositions and/or methods that are used for diversion in matrix treatment embodiments may be used for leakoff control in fracturing treatment embodiments. In other embodiments, the treatment fluids and/or methods are particularly tailored for matrix treatments or for fracturing treatments.

Low temperature, low permeability formations can present a challenge for VDA treatment because the treatment fluid can be too viscous or become too viscous before the acid is sufficiently spent. Also, the acidizing reactions can proceed too slowly to be practical or may not occur at all. In some embodiments, the formation is treated at a temperature at or below 40° C., or at or below 30° C., or at a temperature between 5° C. and 30° C. In embodiments, the formation can contain carbonates, e.g., limestone, dolomite or the like. In some embodiments, the formation can have a permeability less than 20 mD or less than 10 mD.

In some embodiments, a low-temperature, low-permeability carbonate formation such as dolomite is treated. As used herein, “low temperature formations” have a temperature below 40° C. As used herein, “low permeability” formations have a permeability less than 20 mD as determined with a solution of 5% NH4Cl at the formation temperature.

The viscoelastic surfactant systems used with the fluoride source in various embodiments may be any VDA and/or other acid treating fluids, including any co-surfactants, salts, solvents, enhancers, etc. Non-limiting examples of such viscoelastic surfactant systems for acid treatment are those described in U.S. Pat. Nos. 5,979,557; 6,258,859; 6,399,546; 6,435,277; 6,703,352; 7,060,661; 7,084,095; 7,288,505; 7,237,608; 7,303,018 and 7,341,107, which are hereby incorporated herein by reference in their entireties. The VES may be selected from the group consisting of amphoteric, anionic, cationic, zwitterionic, nonionic, and combinations of these. In certain applications, the amphoteric viscoelastic surfactant is used.

Two examples of commercially available viscoelastic surfactants are MIRATAINE® BET-O-30 and MIRATAINE® BET-E-40, available from Rhodia, Inc. (Cranbury, N.J., U.S.A.). These are both betaine surfactants. The VES surfactant in BET-O-30 is oleylamidopropyl betaine. BET-O-30 contains an oleyl acid amide group, including a C17H33 alkene tail group, and is supplied as about 30% active surfactant; the remainder is substantially water, sodium chloride, glycerol and propane-1,2-diol. An analogous suitable material is the BET-E-40, which was used in the examples described below. One chemical name for this compound is erucylamidopropyl betaine. BET-E-40 is also available from Rhodia, Inc. and contains a erucic acid amide group, including a C21H41 alkene tail group, and is supplied as about 40% active ingredient, with the remainder substantially water, sodium chloride, and isopropanol. Erucylamidopropyl betaine is described in U.S. Pat. No. 7,288,505 mentioned above. Such betaines may include their protonated or deprotonated homologs or salts. BET surfactants, and others that are suitable, are described in U.S. Pat. Nos. 6,703,352 and 7,288,505 mentioned above.

The VES in the initial fluid may or may not form micelles. If micelles are formed, they may not be of the proper size, shape, or concentration to create a viscosifying structure, so the initial fluid has an essentially water-like viscosity or is readily pumped and introduced into the formation. As the fluid flows through the formation, however, the concentration of surfactant in the fluid at some location, for example at or near a wormhole tip, increases, due to interactions between the formation and the fluid and its components. As the localized surfactant concentration increases, micelles are formed, or micelle shape or size or concentration increases, and the fluid viscosity increases due to aggregation of viscoelastic surfactant structures. In some embodiments, formation of carbon dioxide by the dissolution of formation carbonate may be a factor in the viscosity increase, as well as increase in pH. With reference to the treatment fluids, when it is described that the fluid is “viscous,” “viscoelastic” or “gelled,” it is meant to refer to those fluids or portions of fluids wherein the viscoelastic surfactant structures have aggregated to provide the diverting feature. Initial fluids or non-gelled fluids in some embodiments may have viscosities below about 20 mPa-s. In contrast, viscoelastic or gelled fluids in embodiments may have viscosities above about 50 mPa-s. Thus, in a particular embodiment, injection of an initial fluid that is not viscous because it contains a VES concentration too low to contribute to the initial viscosity of the fluid may nonetheless be used to treat a formation with a viscous fluid. In some embodiments of matrix acid treatments, for example, this initial fluid system forms wormholes and then gels at or near the tip of the wormhole, causing diversion. In acid fracturing embodiments, the initial fluid may gel where leakoff is high, and so this fluid system may control leakoff.

When a VES is incorporated into fluids used in embodiments, the VES can range from about 0.2% to about 15% by weight of total weight of fluid. In certain embodiments the VES may be used in an amount of from about 0.5% to about 15% by weight of total weight of fluid. In further embodiments, the VES may be used in an amount of from about 0.2% to about 2.5% by weight of total weight of fluid, or from about 0.2% to about 2% by weight of total weight of fluid, or from about 0.4% to about 1% by weight of total weight of fluid. The lower limit of VES may be no less than about 0.2, 0.3, 0.4 0.5, 0.7, 0.9, 1, 2, 3, 4, 5, 6, 7, 8, 9, 10, or 14 percent of total weight of fluid, and the upper limited may be any higher limit no more than about 15 percent of total fluid weight, or no greater than about 15, 14, 13, 12, 11, 10, 9, 8, 7, 6, 5, 2.5, 2, 1, 0.9, 0.8, 0.7, 0.5 or 0.3 percent of total weight of fluid.

In some embodiments, the treatment fluid comprises a fluoride source. In embodiments, the fluoride source can be selected from the group consisting of hydrogen fluoride, ammonium fluoride, ammonium bifluoride, polyvinylammonium fluoride, polyvinylpyridinium fluoride, pyridinium fluoride, imidazolium fluoride, sodium tetrafluoroborate, ammonium tetrafluoroborate, salts of hexafluoroantimony, and the like, and including mixtures thereof. In some embodiments the fluoride source is hydrogen fluoride, and in another embodiment, ammonium bifluoride.

In embodiments, the fluoride source is used in an amount to provide fluoride in an amount from 0.05 to 1 weight percent, or from about 0.1 to about 0.4 weight percent, by total weight of the treatment fluid.

In some embodiments, the treatment fluid can include an acid, e.g., a non-fluoride acid, or combination of acids can include a mineral acid, and in another embodiment, the treatment fluid can include a combination of mineral acid and organic acid. Unless it is apparent from its context the use of the expression “acid” is meant to encompass both the acid and sources of the acid that effectively form the acid to facilitate the treatment. As used herein, mineral acid refers to inorganic, non-fluoride acids. In embodiments, the mineral acid can be selected from HCl and/or H2SO4 and the organic acid, if present, from formic acid and/or oxalic acid such as, for example, hydrochloric acid, nitric acid, phosphoric acid, sulfuric acid, etc.

Organic acids, or precursors of such organic acids, which are useful in stimulating formations may also be used in some embodiments. Sources of acids, such as aldehydes or alcohols that may be oxidized or hydrolyzed to acid, may be used. Examples of organic acids include acetic acid, lactic acid, glycolic acid, sulfamic acid, malic acid, citric acid, tartaric acid, maleic acid, methylsulfamic acid, chloroacetic acid, aminopolycarboxylic acids, 3-hydroxypropionic acid, polyaminopolycarboxylic acids, for example trisodium hydroxyethylethylenediamine triacetate, and salts of these acids and mixtures of these acids and/or salts. Organic acids, salts, hydrolysable esters, and solid acid precursors can also be used to gradually generate protons. Mixtures of these acids and/or their sources may be used.

In certain embodiments only mineral acids are used. For treating carbonate formations, hydrochloric acid is particularly useful. The acid may be present in the treating fluid in an amount of from about 0.3% to about 28% by weight of the acid treatment fluid, or the acid is used in an amount of from about 15% to about 28% by weight of the acid treatment fluid. In certain embodiments from about 17% to about 28% by weight of acid may be used.

In some embodiments, the mineral acid can be selected from HCl and H2SO4 and the organic acid from formic acid, oxalic acid, or from any of the combinations thereof.

In some embodiments, the treatment fluid is substantially free of any short-chain aliphatic acids or aldehydes. If any such acids are present they are only present as an impurity in insubstantial amounts of less than 0.01% by weight of the treatment fluid. As used herein, the expression “saturated short-chain aliphatic acid” and similar expressions are meant to encompass those aliphatic acids having a carbon chain length of six carbons or less and their related aldehydes or precursors. Examples of such short-chain aliphatic acids include, but are not limited to, formic acid, acetic acid, propionic acid, N- and iso-butyric acid, glycolic acid, glyoxylic acid, malonic acid, etc. In certain embodiments there may be no organic acid or aliphatic acid of any chain length. In certain further embodiments there may be no organic acid or saturated aliphatic acid with chain length to up to three carbons.

If desired, the treatment fluid can optionally include a corrosion inhibitor, chelant and/or other acids which in various embodiments may or may not function as either or both of a corrosion inhibitor and chelant. Similarly, in embodiments corrosion inhibitors may include certain chelants and chelants may include certain corrosion inhibitors, although in other embodiments not all corrosion inhibitors are chelants and/or not all chelants are corrosion inhibitors, i.e., corrosion inhibitors may not function as chelating agents and/or chelating agents may not function as corrosion inhibitors.

If desired, the treatment fluid can also include an enzyme or oxidizer, or it can be substantially free of chelant, enzyme and oxidizer additives. Further, the treatment fluid can also include from 2 to 10 volume percent of a mutual solvent, a water-wetting agent or a combination thereof.

In some embodiments, the treatment fluid may include an ionic strength modifier such as a salt other than a fluoride salt present, for example, at a concentration of from 0.1 to 10 percent by weight, or from 0.5 to 5 percent by weight of the fluid. The parameters used in selecting the brine to be used in a particular well are known in the art, and the selection is based in part on the density that is required of the treatment fluid in a given well. Brines that may be used in the embodiments of the current application can comprise CaCl2, CaBr2, NaBr, NaCl, KCl, potassium formate, ZnBr or cesium formate, among others. Brines that comprise CaCl2, CaBr2, and potassium formate may be used for embodiments calling for high densities.

If desired, the treatment fluid in embodiments can additionally include a corrosion inhibitor other than an organic acid. For example, formulations used in the method of the current application can comprise small amounts of corrosion inhibitors based on quaternary amines, for example at a concentration of from about 0.2 or 0.4 to about 1.5, 1.0 or 0.6 weight percent, by weight of the treatment fluid. Some of the organic acids used herein for pH control or acidizing, such as formic acid, where used at from about 0.1 to about 2.0 weight percent, for example, can also function as a corrosion inhibitor, but for the purposes of the current application are excluded from consideration as an additional corrosion inhibitor.

The treatment fluid optionally contains added chelating agents, other than the fluoride source and other acid, for polyvalent cations such as, for example, aluminum, calcium and iron to prevent their precipitation. Chelating agents are sometimes also called sequestering agents, e.g. iron sequestering agents. Chelating agents are added at a concentration, for example, of about 0.5 percent by weight of the treatment fluid.

Optionally, the carrier fluid can further contain one or more additives such as surfactants, shale stabilizing agents such as ammonium chloride, tetramethyl ammonium chloride, or cationic polymers, corrosion inhibitor aids, anti-foam agents, scale inhibitors, emulsifiers, polyelectrolytes, buffers, non-emulsifiers, freezing point depressants, iron-reducing agents, bactericides and the like, provided that they do not interfere with the controlled dissolution of the filtercake as described herein.

The current application, accordingly, provides the following embodiments:

A. A method comprising contacting a carbonate formation at a temperature below 40° C. with a treatment fluid comprising an aqueous mixture of viscoelastic surfactant, a non-fluoride acid and at least one of a fluoride source and chelant.
B. The method of embodiment A wherein the treatment fluid comprises a fluoride source selected from the group consisting of hydrogen fluoride, ammonium fluoride, ammonium bifluoride, polyvinylammonium fluoride, polyvinylpyridinium fluoride, pyridinium fluoride, imidazolium fluoride, sodium tetrafluoroborate, ammonium tetrafluoroborate, salts of hexafluoroantimony, and mixtures thereof.
C. The method of either embodiment A or embodiment B wherein the non-fluoride acid comprises a mineral acid.
D. The method of any one of the preceding embodiments A through C wherein the treatment fluid comprises a chelant.
E. The method of any one of the preceding embodiments A through C wherein the treatment fluid comprises a chelant selected from ethylenediaminetetraacetic acid, N-hydroxyethylenediamine triacetic acid, citric acid, lactate and combinations thereof.
F. The method of any one of the preceding embodiments A through E wherein the carbonate formation comprises a permeability less than or equal to about 10 mD before the contacting.
G. The method of embodiment F wherein the carbonate formation comprises a permeability greater than or equal to about 2000 mD after injection of 10 pore volumes of the treatment fluid.
H. The method of any one of the preceding embodiments A through G wherein the carbonate formation comprises dolomite.
I. The method of any one of the preceding embodiments A through H wherein the treatment fluid comprises the fluoride source in an amount to provide from 0.05 to 1 weight percent fluoride by weight of the treatment fluid.
J. The method of any one of the preceding embodiments A through I wherein the treatment fluid comprises the fluoride source in an amount to provide from 0.1 to 0.4 weight percent fluoride by weight of the treatment fluid.
K. The method of any one of the preceding embodiments A through J wherein the treatment fluid comprises a combination of mineral acid and organic acid.
L. The method of any one of the preceding embodiments A through K wherein the non-fluoride acid comprises a mineral acid selected from HCl, H2SO4, and the combination thereof.
M. The method of embodiment K wherein the non-fluoride acid comprises an organic acid selected from formic acid, oxalic acid and the combination thereof.
N. The method of any one of the preceding embodiments A through M wherein the treatment fluid further comprises a corrosion inhibitor.
O. The method of any one of the preceding embodiments A through N wherein the treatment fluid further comprises an enzyme or oxidizer.
P. The method of any one of the preceding embodiments A through O wherein the treatment fluid comprises from about 0.2% to about 2.5% of the viscoelastic surfactant by total weight of treatment fluid.
Q. A well treatment fluid, comprising an aqueous mixture comprising: a fluoride source an amount to provide from 0.05 to 1 weight percent fluoride; at least 5 percent of a mineral acid by weight of the treatment fluid; and from about 0.2 to 2.5 weight percent of a viscoelastic surfactant.
R. The well treatment fluid of embodiment Q wherein the fluoride source is selected from the group consisting of ammonium fluoride, ammonium bifluoride, polyvinylammonium fluoride, polyvinylpyridinium fluoride, pyridinium fluoride, imidazolium fluoride, sodium tetrafluoroborate, ammonium tetrafluoroborate, salts of hexafluoroantimony, and mixtures thereof.
S. The treatment fluid of either embodiment Q or embodiment R wherein the fluoride source comprises hydrogen fluoride.
T. The treatment fluid of any one of the preceding embodiments Q through S wherein the mineral acid(s) is selected from HCl and H2SO4.
U. The treatment fluid of any one of the preceding embodiments Q through T further comprising a chelant.
V. The treatment fluid of embodiment U wherein the chelant is selected from ethylenediaminetetraacetic acid, N-hydroxyethylenediamine triacetic acid, citric acid, lactate and combinations thereof.
W. The treatment fluid of any one of the preceding embodiments Q through V wherein the fluoride source is present in an amount to provide from 0.1 to 0.4 weight percent fluoride by weight of the treatment fluid.
X. The treatment fluid of any one of the preceding embodiments Q through W comprising from 10 to 30 percent by weight of hydrochloric acid.
Y. The treatment fluid of any one of the preceding embodiments Q through X comprising from 0.2 to 2 percent by weight of the viscoelastic surfactant.
Z. The treatment fluid of any one of the preceding embodiments Q through Y wherein the viscoelastic surfactant comprises betaine.
AA. A method to increase a rate of dissolution of a dolomite formation comprising a permeability less than or equal to about 10 mD and a temperature less than 40° C. in a treatment fluid comprising mineral acid and a viscoelastic surfactant, comprising adding a fluoride source to the treatment fluid in an amount to provide fluoride at from about 0.1 to about 0.4 weight percent by weight of the treatment fluid.
BB. The method of embodiment AA wherein the fluoride source is selected from the group consisting of hydrogen fluoride, ammonium fluoride, ammonium bifluoride, polyvinylammonium fluoride, polyvinylpyridinium fluoride, pyridinium fluoride, imidazolium fluoride, sodium tetrafluoroborate, ammonium tetrafluoroborate, salts of hexafluoroantimony, and mixtures thereof.
CC. The method of either embodiment AA or embodiment BB wherein the treatment fluid further comprises a chelant selected from ethylenediaminetetraacetic acid, N-hydroxyethylenediamine triacetic acid, citric acid, lactate and combinations thereof.
DD. The method of any one of preceding embodiments AA to CC further comprising providing a concentration of the viscoelastic surfactant in the treatment fluid less than 2 percent by total weight of treatment fluid.

### EXAMPLES

### Example 1

Acid treatment of cold dolomite core samples was demonstrated in the lab at 18° C. in a high pressure cell using a VDA fluid made with 15 wt % HCl, 0.25 wt % HF and 2 wt % of a BET-E-40 solution containing 38.6 wt % BET-E-40 (0.77 wt % BET-E40 by total weight of the treatment fluid) and 2 L/m3 of a quaternary amine based corrosion inhibitor solution containing 1 wt % of corrosion inhibitor. The core sample was approximately 4.5 cm diameter by 7 cm long and had a porosity of 9.16 percent.

In stage 1, a 5 wt % solution of aqueous NH4Cl was pumped through the core in the production direction at 2 ml/min for 16 pore volumes, and the average differential pressure was about 1.1 MPa and permeability 2 mD. In stage 2, the 5 wt % NH4Cl solution was pumped through the core in the production direction at 5 ml/min for an additional 8 pore volumes, the average differential pressure was about 2.8 MPa and permeability was 2 mD. In stage 3, the 5 wt % solution of NH4Cl was pumped through the core in the injection direction at 5 ml/min for 8.5 pore volumes, and the differential pressure and permeability were observed to be the same as in stage 2. In stage 4, the VDA fluid was injected into the core at 1 ml/min, the differential pressure rose to 19.8 MPa, and breakthrough occurred at 6.2 pore volumes. In stage 5, the 5 wt % NH4Cl solution was pumped through the core in the production direction at 5 ml/min, the differential pressure was less than 1 kPa and permeability was about 5000 mD. A visual inspection of the core at various depths indicated good wormhole formation which decreased in number farther from the injection surface. This example demonstrates that a VDA containing a relatively small amount of HF and a low VES concentration can be effectively used for acid treatment of a low-permeability dolomite formation at low temperature.

### Example 2

The procedure of Example 1 was repeated using the same HF/HCl VDA fluid in stage 4 with a dolomite core sample having a porosity of 6.32 percent and an initial permeability of 0.2 mD. The results were similar with a final permeability of about 3000 mD and breakthrough at 4.6 pore volumes.

### Example 3

The procedure of Example 1 was repeated using an EDTA/HCl VDA fluid with a dolomite core sample having a porosity of 9.8 percent and an initial permeability of 0.4 mD. The VDA fluid contained 15 wt % HCl, 18 g/L EDTA and 5 mL/L of a corrosion inhibitor solution containing 1 wt % corrosion inhibitor. The final permeability was about 480 mD and breakthrough occurred at 6.7 pore volumes. A visual inspection of the core at various depths indicated, similar to Example 1, good wormhole formation which decreased in number farther from the injection surface. This example demonstrates that a VDA containing EDTA can be effectively used for acid treatment of a low-permeability dolomite formation at low temperature, and suggests that an HF-containing VDA in general and especially the VDA of examples 1 and 2 can be improved with the addition of a chelating agent such as EDTA.

### Comparative Example 1

The procedure of Example 1 was repeated using a baseline VDA fluid prepared without HF or chelant. In Comparative Example 1, the treatment fluid was identical to Example 1 except that it did not contain any HF and had a VES concentration of 7.5 wt %, which is more typical of treatment fluids used to treat dolomite formations above 50° C. The dolomite core had a porosity of 4.40 percent and initial permeability of 1.2 mD. The final permeability was 0.3 mD, and breakthrough did not occur before the maximum differential pressure of the cell was exceeded. This run demonstrated that a VDA without HF or chelant, suitable for dolomites at higher temperatures, would not work with a low-temperature, low-permeability dolomite formation.

### Comparative Example 2

The procedure of Comparative Example 1 was repeated using another baseline VDA fluid prepared without HF or chelant, but with added VES. In Comparative Example 2, the treatment fluid was identical to Comparative Example 1 (did not contain any HF) except that the BET-E-40 proportion was decreased from 7.5 wt % to a total of 2 wt % of the BET-E-40 solution containing 38.6 wt % BET-E-40 (as in Example 1). The dolomite core had a porosity of 4.41 percent and initial permeability of 0.8 mD. The final permeability was 0.4 mD, and breakthrough did not occur before the maximum differential pressure of the cell was exceeded. This run showed that decreasing the surfactant concentration had little effect without any HF or chelant.

### Comparative Example 3

The procedure of Comparative Example 1 was repeated using another baseline VDA fluid prepared without HF or chelant, but with a higher acid concentration. In Comparative Example 3, the treatment fluid was identical to Comparative Example 1 (did not contain any HF, contained 7.5 wt % BET-E-40) except that the HCl concentration was increased from 15 wt % to a total of 20 wt % HCl by weight of the VDA. The dolomite core had a porosity of 6.59 percent and initial permeability of 4.6 mD. The final permeability was 2.5 mD, and breakthrough did not occur before the maximum differential pressure of the cell was exceeded. This run showed that increasing the acid concentration had little effect without any HF or chelant.

The results of these examples are tabulated in Table 1 below:

TABLE 1
Acid Treatment of Dolomite at 18° C.

| | | | Initial | Final | |
|---|---|---|---|---|---|
| Example/ | | | perme- | perme- | PV to |
| Compar- | | Poros- | ability, | ability, | break- |
| ative | Acid system | ity, % | mD | mD | through |
| Ex. 1 | 2% VES, 15% HCl, | 9.16 | 2.0 | ~5000 | 6.2 |
| | 0.25% HF | | | | |
| Ex. 2 | 2% VES, 15% HCl, | 6.32 | 0.2 | ~3000 | 4.6 |
| | 0.25% HF | | | | |
| Ex. 3 | 18 g/L EDTA, 5 | 9.80 | 0.4 | 480 | 6.7 |
| | ml/L corrosion | | | | |
| | inhibitor, 15% HCl | | | | |
| Cp. Ex. 1 | 7.5% VES, 15% HCl | 4.40 | 1.2 | 0.3 | NA* |
| Cp. Ex. 2 | 2% VES, 15% HCl | 4.41 | 0.8 | 0.4 | NA* |
| Cp. Ex. 3 | 7.5% VES, 20% HCl | 6.59 | 4.6 | 2.5 | NA* |

*Maximum differential pressure exceeded

These results indicate that acidizing fluids with lower concentrations of VDA and EDTA or a small amount of HF were able to create wormholes in the formation. Because the amount of HF was very low relative to the HCl, the results indicate that the HF may have a catalytic or other synergistic effect to improve the kinetics of dolomite dissolution in acid. Also, the relatively small amount of HF did not appear to contribute to the formation of precipitates such as CaF2.

Although the methods have been described here, and are most likely used, for hydrocarbon production, they can also be used in injection wells and for production of other fluids, such as water or brine. The particular embodiments disclosed above are illustrative only, as they can be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above can be altered or modified and all such variations are considered within the scope and spirit of the current application. Accordingly, the protection sought herein is as set forth in the claims below.

All patents and other documents cited herein are fully incorporated herein by reference to the extent such disclosure is not inconsistent with this application and for all jurisdictions in which such incorporation is permitted.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. In the claims, means-plus-function clauses are intended to cover the structures described herein as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method, comprising:
contacting a carbonate formation at a temperature below 40° C. with a treatment fluid comprising an aqueous mixture of a viscoelastic surfactant, a non-fluoride acid and at least one of a fluoride source and a chelant.

2. The method of claim 1 wherein the treatment fluid comprises a fluoride source selected from the group consisting of hydrogen fluoride, ammonium fluoride, ammonium bifluoride, polyvinylammonium fluoride, polyvinylpyridinium fluoride, pyridinium fluoride, imidazolium fluoride, sodium tetrafluoroborate, ammonium tetrafluoroborate, salts of hexafluoroantimony, and mixtures thereof.

3. The method of claim 1 wherein the non-fluoride acid comprises a mineral acid.

4. The method of claim 1 wherein the treatment fluid comprises a chelant.

5. The method of claim 1 wherein the treatment fluid comprises a chelant selected from ethylenediaminetetraacetic acid, N-hydroxyethylenediamine triacetic acid, citric acid, lactate and combinations thereof.

6. The method of claim 1 wherein the carbonate formation comprises a permeability less than or equal to about 10 mD before the contacting.

7. The method of claim 6 wherein the carbonate formation comprises a permeability greater than or equal to about 2000 mD after injection of 10 pore volumes of the treatment fluid.

8. The method of claim 1 wherein the carbonate formation comprises dolomite.

9. The method of claim 1 wherein the treatment fluid comprises the fluoride source in an amount to provide from 0.05 to 1 weight percent fluoride, and the viscoelastic surfactant in an amount to provide from 0.2 to 2.5 weight percent viscoelastic surfactant, by weight of the treatment fluid.

10. The method of claim 1 wherein the treatment fluid comprises the fluoride source in an amount to provide from 0.1 to 0.4 weight percent fluoride by weight of the treatment fluid.

11.-20. (canceled)

21. The method of claim 3, wherein the mineral acid is selected from HCl and H₂SO₄.

22. The method of claim 1, wherein the treatment fluid comprises the fluoride source in an amount to provide from 0.1 to 0.4 weight percent fluoride, and from 10 to 30 percent by weight of hydrochloric acid.
